(19) United States
(12) Patent Application Publication
(10) Pub. No.: US 2025/0184711 A1
(43) Pub. Date: Jun. 5, 2025

(54) DISASTER ROAMING METHOD AND APPARATUS, TERMINAL, FIRST COMMUNICATION DEVICE, AND SECOND NETWORK

(71) Applicant: VIVO MOBILE COMMUNICATION CO., LTD., Dongguan (CN)

(72) Inventors: Yizhong ZHANG, Dongguan (CN); Sihan CHENG, Dongguan (CN); Yanchao KANG, Dongguan (CN)

(73) Assignee: VIVO MOBILE COMMUNICATION CO., LTD., Dongguan (CN)

(21) Appl. No.: 19/050,057

(22) Filed: Feb. 10, 2025

Related U.S. Application Data
(63) Continuation of application No. PCT/CN2023/111441, filed on Aug. 7, 2023.

(30) Foreign Application Priority Data
Aug. 12, 2022 (CN) 202210969106.7

(51) Int. Cl. H04W 8/02; H04W 4/90

(52) U.S. Cl. CPC H04W 8/02; H04W 4/90

(57) ABSTRACT

This application discloses a disaster roaming method and apparatus, a terminal, a first communication device, and a second network. The disaster roaming method includes: obtaining, by a terminal, first information, where the first information is information related to a disaster condition (DC) of a first network; and performing, by the terminal based on the first information, a first operation responding to the DC of the first network.

### CROSS-REFERENCE TO RELATED APPLICATIONS

This application is a continuation of International Application No. PCT/CN2023/111441, filed Aug. 7, 2023, which claims priority to Chinese Patent Application No. 202210969106.7, filed Aug. 12, 2022. The entire contents of each of the above-referenced applications are expressly incorporated herein by reference.

### TECHNICAL FIELD

This application pertains to the field of communication technologies, and specifically relates to a disaster roaming method and apparatus, a terminal, a first communication device, and a second network.

### BACKGROUND

In a case that a network side cannot provide a service for a terminal due to a disaster, it is necessary to alleviate impact of service interruption. Disasters on the network side include a disaster occurring in an access network on the network side and/or a disaster occurring in a core network on the network side. When a disaster occurs on the network side, how to transfer the terminal to another network to use a disaster roaming service provided by the another network to alleviate the impact of the service interruption is a technical problem that needs to be resolved urgently.

### SUMMARY

Embodiments of this application provide a disaster roaming method and apparatus, a terminal, a first communication device, and a second network.

According to a first aspect, a disaster roaming method is provided, and the method includes:
obtaining, by a terminal, first information, where the first information is information related to a disaster condition (DC) of a first network; and
performing, by the terminal based on the first information, a first operation responding to the DC of the first network.

According to a second aspect, a disaster roaming method is provided, and the method includes:
sending, by a first communication device, first information to a terminal, where the first information is information related to a disaster condition DC of a first network.

According to a third aspect, a disaster roaming method is provided, and the method includes:
sending, by a second network, eighth indication information to a terminal, where the eighth indication information is used by the terminal to determine that a first network is capable of serving the terminal.

According to a fourth aspect, a disaster roaming apparatus is provided, and the apparatus includes:
an obtaining module, configured to obtain first information, where the first information is information related to a disaster condition DC of a first network; and
a processing module, configured to perform, based on the first information, a first operation responding to the DC of the first network.

According to a fifth aspect, a disaster roaming apparatus is provided, and the apparatus includes:
a first sending module, configured to send first information to a terminal, where the first information is information related to a disaster condition DC of a first network.

According to a sixth aspect, a disaster roaming apparatus is provided, and the apparatus includes:
a second sending module, configured to send eighth indication information to a terminal, where the eighth indication information is used by the terminal to determine that a first network is capable of serving the terminal.

According to a seventh aspect, a terminal is provided, where the terminal includes a processor and a memory, and the memory stores a program or instructions capable of running on the processor, and the program or the instructions are executed by the processor to implement the steps of the method according to the first aspect.

According to an eighth aspect, a terminal is provided, and includes a processor and a communication interface, where the communication interface is configured to obtain first information, the first information is information related to a disaster condition DC of a first network, and the processor is configured to perform, based on the first information, a first operation responding to the DC of the first network.

According to a ninth aspect, a first communication device is provided, where the first communication device includes a processor and a memory, the memory stores a program or instructions capable of running on the processor, and the program or the instructions are executed by the processor to implement the steps of the method according to the second aspect.

According to a tenth aspect, a first communication device is provided, and includes a processor and a communication interface, where the communication interface is configured to send first information to a terminal, and the first information is information related to a disaster condition DC of a first network.

According to an eleventh aspect, a second network is provided, where the second network includes a processor and a memory, the memory stores a program or instructions capable of running on the processor, and the program or the instructions are executed by the processor to implement the steps of the method according to the third aspect.

According to a twelfth aspect, a second network is provided, and includes a processor and a communication interface, where the communication interface is configured to send eighth indication information to a terminal, and the eighth indication information is used by the terminal to determine that a first network is capable of serving the terminal.

According to a thirteenth aspect, a disaster roaming system is provided, and includes a terminal, a first communication device, and a second network, where the terminal may be configured to perform the steps of the disaster roaming method according to the first aspect, the first communication device may be configured to perform the steps of the disaster roaming method according to the second aspect, and the second network may be configured to perform the steps of the disaster roaming method according to the third aspect.

According to a fourteenth aspect, a readable storage medium is provided, where a program or instructions are stored in the readable storage medium, and the program or instructions are executed by a processor to implement the steps of the method according to the first aspect, or to implement the steps of the method according to the second aspect, or to implement the steps of the method according to the third aspect.

According to a fifteenth aspect, a chip is provided, where the chip includes a processor and a communication interface, the communication interface is coupled to the processor, and the processor is configured to run a program or instructions to implement the method according to the first aspect, or to implement the method according to the second aspect, or to implement the method according to the third aspect.

According to a sixteenth aspect, a computer program/a program product is provided, where the computer program/the program product is stored in a storage medium, and the computer program/the program product is executed by at least one processor to implement the steps of the disaster roaming method according to the first aspect, or to implement the steps of the disaster roaming method according to the second aspect, or to implement the steps of the disaster roaming method according to the third aspect.

According to a seventeenth aspect, a transmission apparatus/device is provided, where the apparatus/device is (configured to) configured to implement the steps of the disaster roaming method according to the first aspect, or to implement the steps of the disaster roaming method according to the second aspect, or to implement the steps of the disaster roaming method according to the third aspect.

In the embodiments of this application, the terminal can obtain the first information related to the disaster condition (DC) of the first network, and perform, based on the first information, the first operation responding to the DC of the first network, to mitigate impact of a disaster, on the terminal, occurring on a network side, that is, in the first network, and alleviate impact of service interruption.

### BRIEF DESCRIPTION OF DRAWINGS

FIG. 1 is a schematic diagram of a wireless communication system to which an embodiment of this application can be applied;

FIG. 2 is a schematic diagram of a MOCN in a related art;

FIG. 3 is a schematic flowchart 1 of a disaster roaming method according to an embodiment of this application;

FIG. 4 is a schematic flowchart 2 of a disaster roaming method according to an embodiment of this application;

FIG. 5 is a schematic flowchart 3 of a disaster roaming method according to an embodiment of this application;

FIG. 6 is a diagram 1 of signaling interaction of a disaster roaming method according to an embodiment of this application;

FIG. 7 is a diagram 2 of signaling interaction of a disaster roaming method according to an embodiment of this application;

FIG. 8 is a diagram 3 of signaling interaction of a disaster roaming method according to an embodiment of this application;

FIG. 9 is a diagram 4 of signaling interaction of a disaster roaming method according to an embodiment of this application;

FIG. 10 is a schematic diagram 1 of a structure of a disaster roaming apparatus according to an embodiment of this application;

FIG. 11 is a schematic diagram 2 of a structure of a disaster roaming apparatus according to an embodiment of this application;

FIG. 12 is a schematic diagram 3 of a structure of a disaster roaming apparatus according to an embodiment of this application;

FIG. 13 is a schematic diagram of a structure of a communication device according to an embodiment of this application;

FIG. 14 is a schematic diagram of a hardware structure of a terminal according to an embodiment of this application;

FIG. 15 is a schematic diagram of a structure of a first communication device according to an embodiment of this application; and

FIG. 16 is a schematic diagram of a structure of a second network according to an embodiment of this application.

### DETAILED DESCRIPTION

The technical solutions of the embodiments of this application are clearly described below with reference to the accompanying drawings in the embodiments of this application. Clearly, the described embodiments are some rather than all of the embodiments of this application. All other embodiments obtained by a person of ordinary skill in the art based on embodiments of this application shall fall within the protection scope of this application.

The terms “first”, “second”, and the like in the specification and claims of this application are intended to distinguish between similar objects but do not necessarily indicate a specific order or sequence. It should be understood that the terms used in such a way are interchangeable in proper circumstances, so that the embodiments of this application can be implemented in a sequence other than those shown or described herein. In addition, objects distinguished by “first” and “second” are usually of a same type, and a quantity of the objects is not limited. For example, the first object may be one or more. In addition, in the specification and claims, “and/or” represents at least one of connected objects, and the character “/” usually represents an “or” relationship between associated objects.

It should be noted that the technology described in the embodiments of this application is not limited to a Long Term Evolution (LTE)/an LTE-Advanced (LTE-A) system, and may be further applied to another wireless communication system such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and another system. The terms “system” and “network” in the embodiments of this application are often used interchangeably. The described technology may be used in the system and radio technology mentioned above, or may be used in another system and radio technology. The following descriptions describe a New Radio (NR) system for an example purpose, and NR terms are used in most of the following descriptions. However, these technologies may also be applied to applications other than NR system applications, such as a 6^{th} Generation (6G) communication system.

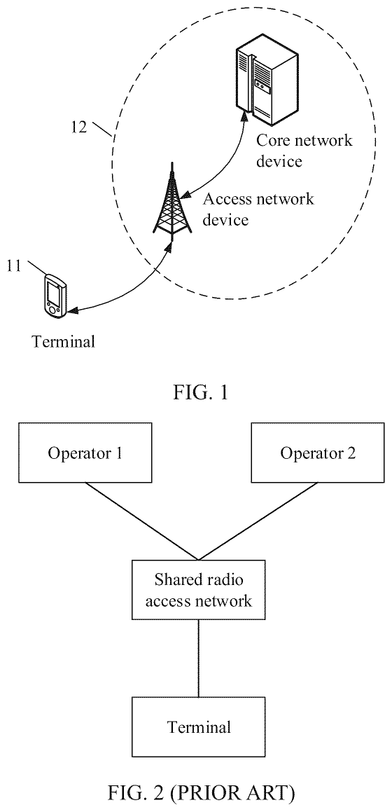

FIG. 1 is a schematic diagram of a wireless communication system to which an embodiment of this application can be applied. The wireless communication system includes a terminal 11 and a network side device 12. The terminal 11 may be a mobile phone, a tablet personal computer, a laptop computer, or referred to as a notebook computer, a personal digital assistant (PDA), a palmtop computer, a netbook, an ultra-mobile personal computer (UMPC), a Mobile Internet Device (MID), an augmented reality (AR)/virtual reality (VR) device, a robot, a wearable device, vehicle user equipment (VUE), pedestrian user equipment (PUE), a smart household (a household device with a wireless communication function, such as a refrigerator, a television, a washing machine, or a furniture), a game machine, a personal computer (PC), a teller machine, a self-service machine, or another terminal side device. The wearable device includes a smartwatch, a smart band, a smart headset, smart glasses, smart jewelry (a smart wristlet, a smart bracelet, a smart ring, a smart necklace, a smart anklet, a smart leglet, or the like), a smart wristband, a smart dress, or the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a transmission reception point (Transmitting Receiving Point, TRP), or another appropriate term in the field. Provided that a same technical effect is achieved, the base station is not limited to a specific technical vocabulary. It should be noted that in the embodiments of this application, only a base station in the NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a local NEF (L-NEF), a Binding Support Function (BSF), an Application Function (AF), or the like. It should be noted that in the embodiments of this application, only a core network device in the NR system is used as an example for description, and a specific type of the core network device is not limited.

With reference to the accompanying drawings, the following describes in detail a disaster roaming method and apparatus, a terminal, a first communication device, and a second network provided in embodiments of this application by using some embodiments and application scenarios thereof.

Embodiments of this application provide a solution to a problem that a disaster occurring on a network side has severe impact on a terminal. To facilitate clearer understanding of the embodiments of this application, the following first describes some related technical knowledge.

### I. Introduction to an MOCN.

A Multi-Operator Core Network (MOCN) means that a plurality of operators share one wireless network, that is, one same base station may be simultaneously connected to Core Network (CN) of the plurality of operators (OP).

FIG. 2 is a schematic diagram of a MOCN in a related art. As shown in FIG. 2, operators share a wireless network resource (a cell carrier frequency), that is, share a Radio Access Network (RAN) node, but do not share CN nodes, and the CN nodes belong to different operators. The different operators, for example, are an operator 1 (OP1) and an operator 1 (OP2) in the figure.

The RAN node broadcasts, by using a system broadcast message, information about a supported Public Land Mobile Network (PLMN), for example, a PLMN identity ID. When initiating Radio Resource Control (RRC) connection establishment to an RAN, the terminal provides the RAN with information about which operator to access, for example, carries a PLMN ID of a target operator. The RAN routes a request of the terminal to a CN of a corresponding operator based on the information.

II. In the Related Art, how is a Terminal Registered when a Disaster Occurs in the RAN.

Step 1: If the terminal wants to obtain a disaster roaming service of a PLMN 2 (the RAN), the terminal first needs to perform initial registration on the PLMN 2, where the initial registration has a special registration type: disaster roaming initial registration.

Step 2: During registration, the terminal may report that the terminal is from a PLMN with a Disaster Condition (DC) (PLMN with Disaster Condition), and this PLMN ID is in plaintext without a need for security context.

Step 3: After receiving a registration message, an Access and Mobility Management Function (AMF) derives, based on the PLMN ID provided by the terminal or a Subscription Concealed Identifier (SUCI) or a Globally Unique Temporary Identity (5G-GUTI), that the PLMN ID is with a DC, and the AMF determines whether a disaster roaming service can be provided. If the PLMN ID is without a DC or disaster roaming cannot be provided, the AMF rejects the terminal by using a proper cause value.

Step 4: After the AMF makes a positive determining, the network needs to perform authentication on the terminal. In some embodiments, the AMF provides an Authentication Server Function (AUSF) with indication information, to indicate that the terminal is providing the disaster roaming service. If the indication information is provided, the AUSF also provides Unified Data Management (UDM) with the indication information.

Step 5: After the authentication succeeds, the AMF may provide indication information indicating that the terminal is performing DC roaming, and the UDM provides the AMF with subscription data corresponding to the terminal based on the indication information.

Step 6: The AMF accepts a registration request of the terminal, and defines a Registration Area (RA) of the terminal in a response message, which is limited to an area with the DC; in addition, the AMF may provide the terminal with a new PLMN list and a disaster range, so that when this PLMN is with the DC, the terminal determines a PLMN that supports the disaster roaming service.

### III. Encryption and Integrity Protection Mechanisms in 5G.

1. Most of all NAS messages of the terminal need to pass integrity protection detection. Otherwise, the terminal needs to discard this message, even if security context is established. Therefore, integrity protection is the most important.

2. The security context is established by using primary authentication and key agreement processes, and is enabled after a Non-Access Stratum (NAS) Security Mode Command (SMC) process.

3. If the terminal has no security context, the terminal first needs to establish the security context with the AMF by using an initial registration message. After the security context is enabled, that is, the NAS SMC process is completed, plaintext or non-plaintext messages to be sent are all placed in a complete message of an SMC and sent to the AMF.

4. A used encryption parameter completely depends on a network configuration of the AMF. This means that encryption modes between different PLMNs are definitely different.

IV. In a MOCN sharing scenario, how to support the terminal to perform disaster roaming is an urgent problem to be resolved.

V. In a scenario of inter-network roaming, how to support the terminal to perform disaster roaming is an urgent problem to be resolved.

A disaster roaming method provided in an embodiment of this application may be applied to a terminal that cannot be served due to a disaster occurring on a network side.

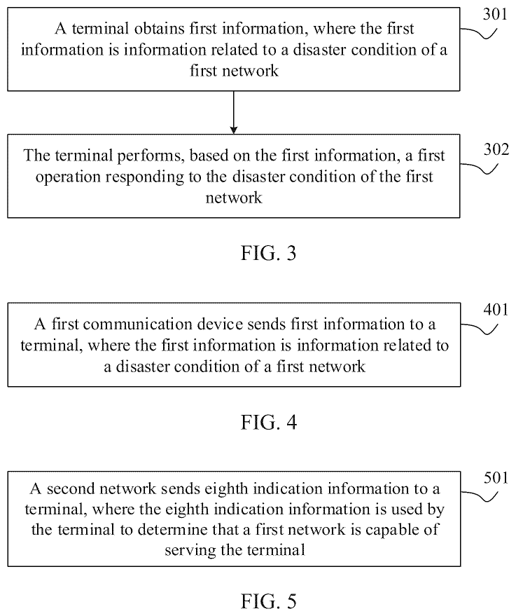

FIG. 3 is a schematic flowchart 1 of a disaster roaming method according to an embodiment of this application. As shown in FIG. 3, the method includes step 301.

Step 301: A terminal obtains first information, where the first information is information related to a disaster condition DC of a first network.

Step 302: The terminal performs, based on the first information, a first operation responding to the DC of the first network.

In a related art, the first network may serve the terminal. In a case that a disaster occurs in the first network, the first network is incapable of serving the terminal any longer. It may be learned that a disaster occurring in the first network severely affects the terminal.

In this embodiment of this application, the terminal may obtain the first information related to the DC of the first network, and perform, based on the first information, the first operation responding to the DC of the first network.

According to the disaster roaming method provided in this embodiment of this application, the terminal can obtain the first information related to the DC of the first network, and perform, based on the first information, the first operation responding to the DC of the first network, to mitigate impact of the disaster, on the terminal, occurring on a network side, that is, in the first network, and alleviate impact of service interruption.

In some embodiments, the first network may be a network with a DC, or the first network may be a network with a CN DC. Herein, that the network has a DC may include that a disaster occurs in an access network on the network side and/or a disaster occurs in a core network on the network side.

The first network is, for example, a PLMN network with a DC (PLMN with Disaster Condition). In some embodiments, the first network is, for example, a PLMN network with a CN DC (PLMN with CN Disaster Condition).

In some embodiments, the first information may include at least one of the following:
1. First indication information, used by the terminal to determine that the first network is incapable of serving the terminal.
2. Second indication information, used by the terminal to determine to access a second network.
3. Third indication information, used to request the terminal to perform network selection.

In some embodiments, the third indication information may be used to request the terminal to select another network different from the first network.
4. Fourth indication information, used to request the terminal to deregister or detach from the first network.

In some embodiments, deregistering from the first network may include: locally deregistering from the first network or deregistering from the first network by using signaling.

In some embodiments, detaching from the first network may include: locally detaching from the first network or detaching from the first network by using signaling.

It should be noted that in an evolved packet data gateway (Evolved Packet System, EPS), registration may also be referred to as attach, and deregistration may also be referred to as detach (de-attach). In some embodiments, a technical meaning of deregistering from the first network may be the same as that of detaching from the first network.
5. Fifth indication information, used by the terminal to determine to perform a handover process from the first network to the second network or an interoperation process between the first network and the second network.

In some embodiments, the fifth indication information may carry an EPS ID, to indicate the terminal to use an EPS corresponding to the EPS ID as the second network to perform an interoperation process.
6. Sixth indication information, used by the terminal to determine to enter an idle state.

In some embodiments, the terminal enters an idle state, for example, connection management (CM) of the terminal is in an idle state.

In some embodiments, the second network may be a network offering a disaster roaming service.

In some embodiments, the second network is, for example, a PLMN network offering a disaster roaming service (PLMN offering disaster roaming service).

In some embodiments, the first operation may include at least one of the following:
(1) Releasing a communication resource between the terminal and the first network.

In some embodiments, the first network is, for example, a PLMN 1, and the terminal releases the communication resource between the terminal and the first network, for example, the terminal releases a network resource between the terminal and the PLMN 1.

It should be noted that, in this embodiment of this application, the network resource is, for example, a resource of an NI frequency band, an air interface resource, an RRC resource, a Signaling Radio Bearer (SRB), a Data Radio Bearer (DRB), or the like.

In some embodiments, if the terminal may continue to use a current RAN node, after a communication resource between the terminal and the current RAN node is released, a communication resource is re-established with the terminal.
(2) Releasing a communication resource between the terminal and a first communication device.

In some embodiments, the first communication device is, for example, a RAN node.

In some embodiments, if the terminal may continue to use a current RAN node, a communication resource between the terminal and the current RAN node may not be released.
(3) Establishing a communication resource related to the second network with the first communication device.

In an embodiment, before the communication resource between the terminal and the RAN node is released, if the terminal may continue to use the current RAN node to establish the communication resource related to the second network, the communication resource between the terminal and the current RAN node may not be released, and the communication resource related to the second network is directly established by using the current RAN node.
(4) Deregistering or detaching from the first network.
(5) Entering an idle state.
(6) Performing network selection.
(7) Performing an interoperation process from the first network to the second network.

In some embodiments, the terminal performs the interoperation process, and may carry a PLMN ID, a 5G-GUTI, and/or a disaster roaming indication.
(8) Sending a registration request message to the second network.

In some embodiments, in a case that the first operation includes entering an idle state, the terminal in the idle state may meet any of the following:
a. RRC of the terminal is in a connected state, and CM of the terminal is in an idle state; and
b. RRC of the terminal is in an idle state, and CM of the terminal is in an idle state.

In some embodiments, the registration request message may include at least one of the following:
1. A registration type, used to indicate that the terminal performs registration related to a disaster condition.

In some embodiments, the terminal may send, to the second network by using initial registration whose registration type is disaster roaming initial registration, a registration request related to disaster roaming.
2. An ID of the first network.
3. An ID of the terminal.
4. Seventh indication information, used to indicate that the first network is incapable of serving the terminal.

In some embodiments, an implementation of performing the interoperation process from the first network to the second network may include:
sending at least one of the following target information to the second network:
1. an ID of the first network;
2. an ID of the terminal; or
3. seventh indication information, used to indicate that the first network is incapable of serving the terminal.

In some embodiments, if both an EPS of the PLMN 1 and a 5G system (5GS) of the PLMN 1 belong to a same operator, and there may be an N26 interface between the EPS and the 5GS, the terminal may perform an interoperation process through the N26 interface to directly transfer the terminal from the 5GS to the EPS. In this case, it is unnecessary for the terminal to re-register with the EPS. Therefore, it is unnecessary to indicate the terminal to perform the registration related to the disaster condition, and the target information may not include the registration type.

In some embodiments, the terminal may send second information, where the second information is used to indicate that the terminal has a capability of supporting the second network.

In some embodiments, an occasion in which the terminal sends the second information may be before a disaster occurs in the first network, for example, when the terminal is registered with the first network, that is, the terminal sends the second information to the first network at this time; or may be when a disaster occurs in the first network, that is, the terminal sends the second information to the first communication device at this time, for example, the terminal sends the second information to the RAN node.

In some embodiments, when the second network is an EPS, the second information may be used to indicate a capability of the terminal to support an S1 mode. In some embodiments, the second information may be used to indicate a capability of the terminal to support an interoperation process with the EPS.

In some embodiments, that the first network is incapable of serving the terminal may include:

A CN disaster occurs in the first network; or the first network is in the DC.

In some embodiments, in a case that a Radio Access Technology (RAT) of the first network is the same as a RAT of the second network, the first operation includes at least one of the following: releasing the communication resource between the terminal and the first network, releasing the communication resource between the terminal and the first communication device, establishing the communication resource related to the second network with the first communication device, deregistering or detaching from the first network, entering an idle state, performing network selection, or sending the registration request message to the second network. For example, the first network is the 5GS of the PLMN 1, and the second network is a 5GS of a PLMN 2. Herein, the first network and the second network belong to different operator networks.

In some embodiments, in a case that the RAT of the first network is different from the RAT of the second network, the first operation includes at least one of the following: releasing the communication resource between the terminal and the first network, releasing the communication resource between the terminal and the first communication device, establishing the communication resource related to the second network with the first communication device, deregistering or detaching from the first network, entering an idle state, performing network selection, performing the interoperation process from the first network to the second network, or sending the registration request message to the second network. For example, the first network is the EPS of the PLMN 1, and the second network is the 5GS of the PLMN 1. Herein, the first network and the second network may belong to a same operator network.

In some embodiments, an implementation of obtaining the first information by the terminal may include: The terminal receives the first information from the first communication device.

In some embodiments, the first communication device may send the first information to the terminal, and the terminal receives the first information, and performs the first operation based on the first information.

In some embodiments, the first information may further include an ID of the second network.

In some embodiments, the first communication device is, for example, a RAN node, and the second network is, for example, a PLMN. The RAN node selects a PLMN to perform sending to the terminal, and the terminal may access the PLMN based on a PLMN ID without performing PLMN selection.

In some embodiments, the terminal may not perform network selection.

In some embodiments, the first information may be represented based on at least one of the following:
(1) A cause value.

In some embodiments, for example, the cause value is in a form of cause value, and different cause values may be used to represent at least one piece of the first indication information to the sixth indication information. For example, cause value #3 is used to represent the first indication information, that is, cause value #3 may be used to represent that the first network is incapable of serving the terminal. For another example, cause value #5 is used to represent the second indication information, that is, cause value #5 may be used to represent indicating the terminal to access the second network.
(2) A bit indication.

In some embodiments, a Z-bit indication may be used to represent at least one piece of the first indication information to the sixth indication information. A 1-bit indication is used as an example, and 0/1 may be used to respectively represent the first indication information and the second indication information. For example, 0 may be used to represent that the first network is incapable of serving the terminal. For another example, 1 may be used to represent indicating the terminal to access the second network.

In some embodiments, the first information may be carried in a broadcast message, a System Information Block (SIB) message, and/or an RRC message.

In some embodiments, the first information may be carried in at least one of the following:
a. an RRC reconfiguration message;
b. an RRC release message; or
c. a system broadcast message.

In some embodiments, the terminal may obtain eighth indication information, where the eighth indication information is used by the terminal to determine that the first network is capable of serving the terminal; and the terminal performs, based on the eighth indication information, at least one of the following:
1. Performing network selection.

In some embodiments, the terminal may perform PLMN selection. It may be understood that the terminal returns to the first network based on PLMN selection.
2. Deregistering or detaching from the second network.

In some embodiments, the terminal may obtain the eighth indication information from the second network or the first communication device, and perform network selection and/or deregister or detach from the second network based on the eighth indication information.

In an embodiment, the terminal may deregister or detach from the second network based on the eighth indication information, and select to return to the first network.

In some embodiments, the eighth indication information may be carried in at least one of the following:
(1) a deregistration request (DEREGISTRATION REQUEST) message or a detach request (DETACH REQUEST) message;
(2) a UE configuration update command (UE CONFIGURATION UPDATE COMMAND) message;
(3) a registration reject (REGISTRATION REJECT) message; or
(4) a downlink non-access stratum transport (DL NAS TRANSPORT) message.

In some embodiments, that the first network is capable of serving the terminal may include:

In a case that the CN disaster of the first network ends or the DC of the first network ends, the first network is capable of serving the terminal.

In some embodiments, that the first network is capable of serving the terminal in the eighth indication information may be understood as follows: In the case that the CN disaster of the first network ends or the DC of the first network ends, the first network may continue to serve the terminal.

In some embodiments, in the EPS, the terminal may be notified of the end of the disaster by using the UE configuration update command message, the detach request message, or the DL NAS TRANSPORT message.

In some embodiments, before the terminal obtains the eighth indication information, the terminal may obtain ninth indication information, where the ninth indication information is used to request the terminal to re-register with the second network; and
the terminal sends the registration request message based on the ninth indication information.

In some embodiments, the terminal may obtain the ninth indication information from the second network or the first communication device, to indicate re-registration required to the terminal. After receiving the ninth indication information, the terminal may send the registration request message to the second network based on the ninth indication information.

It should be noted that, when the terminal initiates a registration request, because the terminal is in the second network, that the terminal requests to initiate the registration request message may also be understood that the terminal re-initiates a registration process to the second network.

It should be further noted that the network side may send the ninth indication information to the terminal by using UE configuration update (UCU), to request the terminal to re-register. The terminal performs registration after receiving the ninth indication information. The network side may further notify, based on the registration reject message, the terminal that the DC of the first network ends, that is, send the eighth indication message to the terminal. The terminal returns to the first network after receiving the eighth indication message.

The disaster roaming method provided in this embodiment of this application may be applied to the first communication device, and the first communication device is, for example, the RAN node.

FIG. 4 is a schematic flowchart 2 of a disaster roaming method according to an embodiment of this application. As shown in FIG. 4, the method includes step 401.

Step 401: A first communication device sends first information to a terminal, where the first information is information related to a disaster condition DC of a first network.

In some embodiments, the first communication device may send the first information related to the DC of the first network to the terminal, so that the terminal performs, based on the first information, a first operation responding to the DC of the first network.

According to the disaster roaming method provided in this embodiment of this application, the first communication device may send the first information related to the DC of the first network to the terminal, so that the terminal performs, based on the first information, the first operation responding to the DC of the first network, to mitigate impact of a disaster, on the terminal, occurring on a network side, that is, in the first network.

In some embodiments, the first network may be a network with a DC, or the first network may be a network with a CN DC.

In some embodiments, the first information may include at least one of the following:
1. first indication information, used by the terminal to determine that the first network is incapable of serving the terminal;
2. second indication information, used by the terminal to determine to access a second network;
3. third indication information, used to request the terminal to perform network selection;
4. fourth indication information, used to request the terminal to deregister or detach from the first network;
5. fifth indication information, used by the terminal to determine to perform a handover process from the first network to the second network or an interoperation process between the first network and the second network; or
6. sixth indication information, used by the terminal to determine to enter an idle state.

In some embodiments, the second network may be a network offering a disaster roaming service.

In some embodiments, that the first network is incapable of serving the terminal may include:

A CN disaster occurs in the first network; or the first network is in the DC.

In some embodiments, the first information may further include an ID of the second network.

In some embodiments, the first information is represented based on at least one of the following:
(1) a cause value; or
(2) a bit indication.

In some embodiments, the first information may be carried in at least one of the following:
a. an RRC reconfiguration message;
b. an RRC release message; or
c. a system broadcast message.

In some embodiments, the first communication device may send eighth indication information to the terminal, where the eighth indication information is used by the terminal to determine that the first network is capable of serving the terminal.

In some embodiments, the eighth indication information may be carried in at least one of the following:
(1) a deregistration request message or a detach request message;
(2) a UE configuration update command message;
(3) a registration reject message; or
(4) a downlink non-access stratum transport message.

In some embodiments, that the first network is capable of serving the terminal may include:

In a case that the CN disaster of the first network ends or the DC of the first network ends, the first network is capable of serving the terminal.

In some embodiments, before the first communication device sends the eighth indication information to the terminal, the first communication device may send ninth indication information to the terminal, where the ninth indication information is used to request the terminal to re-register with the second network.

The disaster roaming method provided in this embodiment of this application may be applied to the second network, and the second network is, for example, a PLMN offering a disaster roaming service.

FIG. 5 is a schematic flowchart 3 of a disaster roaming method according to an embodiment of this application. As shown in FIG. 5, the method includes step 501.

Step 501: A second network sends eighth indication information to a terminal, where the eighth indication information is used by the terminal to determine that a first network is capable of serving the terminal.

In some embodiments, the second network may send the eighth indication information to the terminal, to indicate the terminal that the first network is capable of serving the terminal. After receiving the eighth indication information, the terminal may perform at least one of the following: performing network selection; or deregistering or detaching from the second network.

In an embodiment, after receiving the eighth indication information, the terminal ends disaster roaming. In some embodiments, the terminal may deregister or detach from the second network, and perform network selection to return to the first network, so that the first network serves the terminal.

According to the disaster roaming method provided in this embodiment of this application, in a case that the first network can serve the terminal, the second network can indicate, by using the eighth indication information, the terminal that the first network is capable of serving the terminal, so that the terminal can return to the first network, and the first network serves the terminal to end disaster roaming.

In some embodiments, the first network may be a network with a DC, or the first network may be a network with a CN DC.

In some embodiments, the second network may be a network offering a disaster roaming service.

In some embodiments, the eighth indication information may be carried in at least one of the following:
(1) a deregistration request message or a detach request message;
(2) a UE configuration update command message;
(3) a registration reject message; or
(4) a downlink non-access stratum transport message.

In some embodiments, that the first network is capable of serving the terminal may include:

In a case that a core network CN disaster of the first network ends or a disaster condition DC of the first network ends, the first network is capable of serving the terminal.

In some embodiments, before the second network sends the eighth indication information to the terminal, the second network may send ninth indication information to the terminal, where the ninth indication information is used to request the terminal to re-register with the second network.

In some embodiments, the second network receives a registration request message sent by the terminal, where
the registration request message includes at least one of the following:
1. a registration type, used to indicate that the terminal performs registration related to a disaster condition;
2. an identifier ID of the first network;
3. an ID of the terminal; or
4. seventh indication information, used to indicate that the first network is incapable of serving the terminal.

In an embodiment, the second network may first send, to the terminal, the ninth indication information used to request the terminal to re-register with the second network. In a case that the terminal receives the ninth indication information, the terminal sends the registration request message to the second network. After receiving the registration request message sent by the terminal, the second network may reject a registration request of the terminal by sending the registration reject message to the terminal, and send the eighth indication information to the terminal by using the registration reject message, to indicate the terminal that the first network is capable of serving the terminal. The terminal may return to the first network based on the eighth indication information, so that the first network serves the terminal.

In some embodiments, the second network may receive at least one of the following target information sent by the terminal:
1. an ID of the first network;
2. an ID of the terminal; or
3. seventh indication information, used to indicate that the first network is incapable of serving the terminal; and
the second network performs an interoperation process of the terminal from the first network to the second network based on the target information.

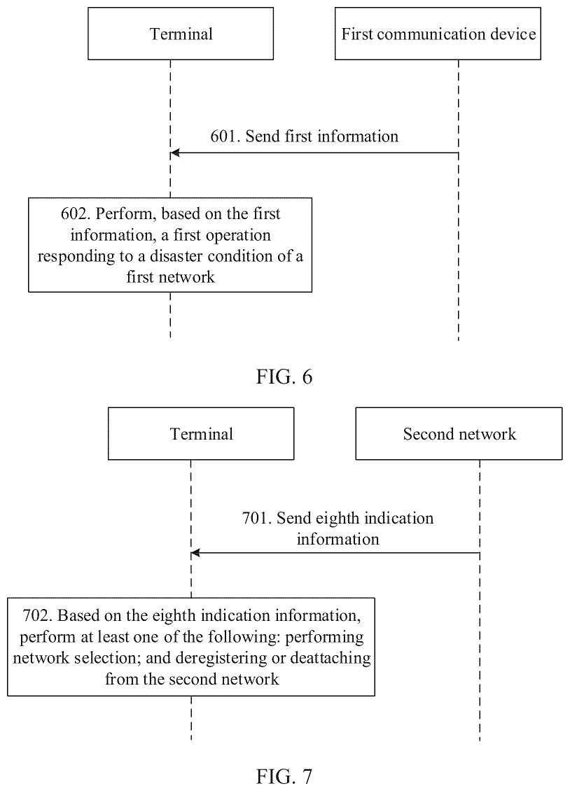

FIG. 6 is a diagram 1 of signaling interaction of a disaster roaming method according to an embodiment of this application. As shown in FIG. 6, the method includes step 601 and step 602.

Step 601: A first communication device sends first information to a terminal.

The first information is information related to a DC of a first network.

Step 602: The terminal performs, based on the first information, a first operation responding to the DC of the first network.

In some embodiments, the first communication device sends the first information to the terminal. The terminal receives the first information, and may perform, based on the first information, the first operation responding to the DC of the first network.

FIG. 7 is a diagram 2 of signaling interaction of a disaster roaming method according to an embodiment of this application. As shown in FIG. 7, the method includes step 701 and step 702.

Step 701: A second network sends eighth indication information to a terminal.

The eighth indication information is used by the terminal to determine that a first network is capable of serving the terminal.

Step 702: The terminal performs, based on the eighth indication information, at least one of the following: performing network selection; or deregistering or detaching from the second network.

In some embodiments, the second network may send the eighth indication information to the terminal, to indicate the terminal that the first network is capable of serving the terminal. After receiving the eighth indication information, based on the eighth indication information, the terminal may perform network selection, and/or deregister or detach from the second network.

The following uses examples to describe the disaster roaming method provided in embodiments of this application.

I. When a CN disaster occurs in the first network, the terminal obtains the first information from the first communication device, and the terminal performs disaster roaming registration in the second network.

The following uses an example in which the first communication device is a shared (Shared) RAN, the first network is a CN of a PLMN 1, and the second network is a CN of a PLMN 2 for description.

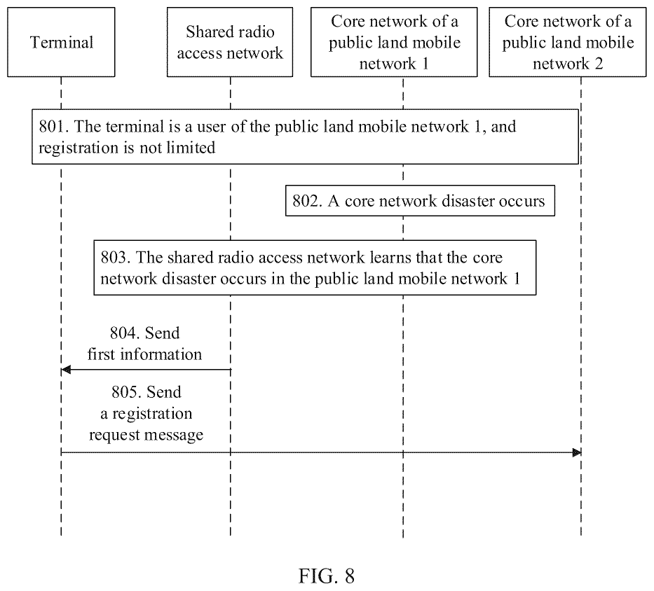

FIG. 8 is a diagram 3 of signaling interaction of a disaster roaming method according to an embodiment of this application. As shown in FIG. 8, the method includes step 801 to step 805.

Step 801: A terminal obtains a service from the PLMN 1, or is in an idle (IDLE) state after being registered with the PLMN 1, or the terminal camps on only a cell belonging to the PLMN 1. Whether the terminal is registered with the PLMN 1 is not limited in this embodiment of this application.

Step 802: A CN disaster occurs in the PLMN 1.

In some embodiments, the PLMN 1 cannot continue to serve the terminal, for example, the CN disaster occurs in the PLMN 1. Because a disaster occurs in the PLMN 1, users of the PLMN 1 are switched to a connection management idle (CM-IDLE) state.

Step 803: The shared RAN learns that the CN disaster occurs in the PLMN 1.

Step 804: The shared RAN sends first information to the terminal.

In some embodiments, the first information may include:
1. first indication information, used by the terminal to determine that the first network is incapable of serving the terminal;
2. second indication information, used by the terminal to determine to access the second network (the PLMN 2);
3. fourth indication information, used to request the terminal to locally deregister from the first network; and
4. sixth indication information, used by the terminal to determine to enter an idle state.

It should be noted that the sixth indication information may be used together with other indication information.

In some embodiments, the first information may be sent by using at least one of the following: an RRC reconfiguration message; an RRC release message; or a system broadcast message.

In some embodiments, the first information may be a cause value.

In some embodiments, the first information further includes: a PLMN 2 ID.

In some embodiments, after obtaining the first information, the terminal may release a communication resource between the terminal and the first network (the PLMN 1) and a communication resource between the terminal and the shared RAN.

Step 805: The terminal sends a registration request message to the PLMN 2.

In some embodiments, the terminal may send, to the PLMN 2 by using initial registration whose registration type is disaster roaming initial registration, a registration request related to disaster roaming.

II. When a CN disaster occurs in the first network, the terminal obtains the first information from the first communication device, and the terminal performs an interoperation process in the second network.

The following uses an example in which the first communication device is a shared RAN, the first network is a 5GS of a PLMN 1, and the second network is an EPS of a PLMN 2 for description.

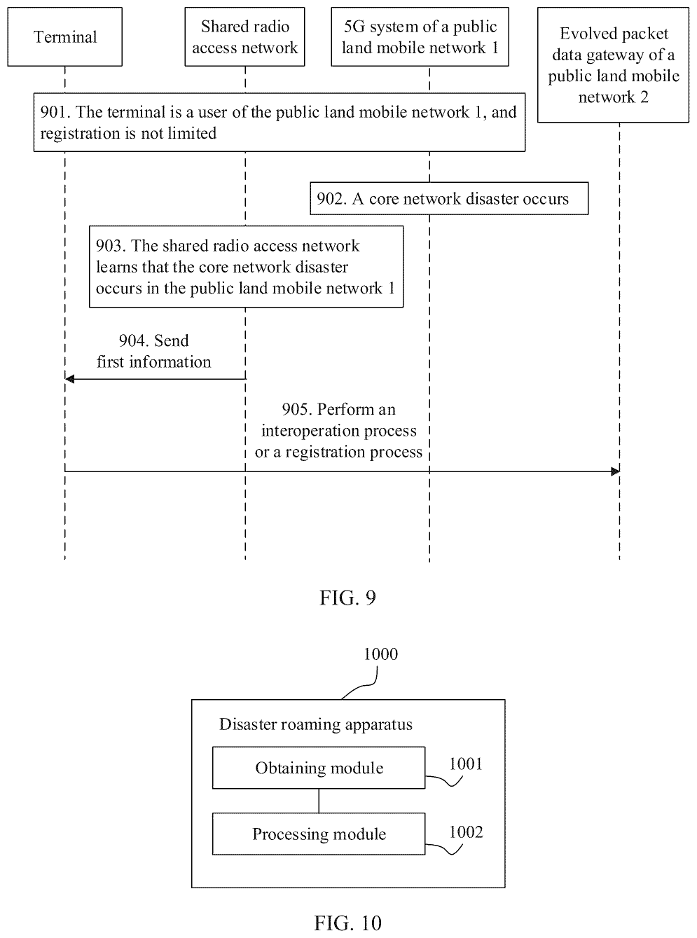

FIG. 9 is a diagram 4 of signaling interaction of a disaster roaming method according to an embodiment of this application. As shown in FIG. 9, the method includes step 901 to step 905.

Step 901: A terminal obtains a service from the PLMN 1, or is in an idle state after being registered with the PLMN 1, or the terminal camps on only a cell belonging to the PLMN 1. Whether the terminal is registered with the PLMN 1 is not limited in this embodiment of this application.

Step 902: A CN disaster occurs in the PLMN 1.

In some embodiments, the PLMN 1 cannot continue to serve the terminal, for example, the CN disaster occurs in the PLMN 1. Because a disaster occurs in the PLMN 1, users of the PLMN 1 are switched to a CM-IDLE state.

Step 903: The shared RAN learns that the CN disaster occurs in the PLMN 1.

Step 904: The shared RAN sends first information to the terminal.

In some embodiments, the first information may include:
1. second indication information, used by the terminal to determine to access the second network (the EPS);
2. fifth indication information, used by the terminal to determine to perform a handover process or an interoperation process; and
3. sixth indication information, used by the terminal to determine to enter an idle state.

It should be noted that the sixth indication information may be used together with other indication information.

In some embodiments, the first information may be sent by using at least one of the following: an RRC reconfiguration message; an RRC release message; or a system broadcast message.

In some embodiments, the first information may be a cause value.

In some embodiments, the first information further includes: a PLMN 2 ID.

Step 905: The terminal performs an interoperation process or a registration process on the PLMN 2.

In some embodiments, step 905 may include the following two cases:

Case 1: The terminal performs the interoperation process on the PLMN 2. In some embodiments, the terminal performs an interoperation process from the first network to the second network, provided that no disaster occurs in network elements involved in the interoperation process. The network elements involved in the interoperation process are, for example, an AMF, an SMF, a PCF, a UPF, and UDM.

In some embodiments, that the terminal performs an interoperation process from the first network to the second network includes: The terminal sends at least one of the following to the second network:
a. an ID of the first network;
b. an ID of the terminal; or
c. seventh indication information, used to indicate that the first network cannot continue to serve the terminal.

Case 2: The terminal performs the registration process on the PLMN 2.

In some embodiments, the terminal may send a registration request message to the PLMN 2, where the registration request message may include at least one of the following:
a. a registration type, used to indicate that the terminal performs registration related to a disaster condition;
b. an ID of the first network;
c. an ID of the terminal; or
d. seventh indication information, used to indicate that the first network cannot continue to serve the terminal.

In some embodiments, after step 905, the terminal may send a deregistration message by using the second network, or send a UCU with one piece of indication information, which indicates re-registration required, to learn that the CN disaster of the first network ends. For UCU+indication, after receiving the registration request message of the terminal, a network side rejects a registration request of the terminal and sends the eighth indication information. The eighth indication information may be a cause value, and the eighth indication information is used to indicate that the first network can serve the terminal.

III. When a CN disaster occurs in the first network, the terminal may obtain the first information from the RAN, where the first information is used to indicate the terminal to send an initial NAS message, and perform operations such as initial registration and re-registration.

In some embodiments, the RAN may further indicate a PLMN 2 ID to the terminal. In this case, the terminal may not perform network selection.

In some embodiments, the terminal may release a network resource between the terminal and the PLMN 1.

It should be noted that, in this embodiment of this application, the network resource is, for example, a resource of an NI frequency band, an air interface resource, an RRC resource, an SRB, or a DRB.

In some embodiments, if the terminal may continue to use a current RAN node, after a communication resource between the terminal and the current RAN node is released, a communication resource is re-established with the terminal.

IV. When a CN disaster occurs in the first network, the terminal may obtain the first information from the RAN, where the first information is used to indicate the terminal to perform an interoperation process from the 5GS to the EPS.

In some embodiments, the first information may carry an EPS ID.

In some embodiments, the terminal may perform the interoperation process and carry a PLMN ID, a 5G-GUTI, and/or a disaster roaming indication.

V. An R17 mechanism may be applied to an EPS. When a CN disaster occurs in the first network, the terminal obtains broadcast information from an eNodeB of the second network.

In some embodiments, the broadcast information may carry a special registration type, an identifier, and the like.

There is no difference in registration procedures in a MOCN scenario. However, because the terminal is required not to perform network selection, an important enhancement in Phase 2 should be:

The terminal obtains indication information (the first information) from the RAN, where the first information is used to indicate the terminal to send an initial NAS message. The first information may be a cause value, or may be a bit indication, a broadcast message, a SIB message, an RRC message, or the like.

It should also be noted that, in an architecture of inter-network roaming, the terminal needs to transfer from the 5GS of the PLMN 1 to the EPS of the PLMN 1. Practice of inter-network roaming is that the PLMN 1 generates a new PLMN ID, and the PLMN ID is an EPLMN of the terminal. Therefore, from a terminal perspective, it is actually to access an equivalent PLMN. Therefore, an EPS corresponding to an old PLMN means a forbidden PLMN from a perspective of the new PLMN ID. From this perspective, handover from the 5GS of the operator 1 to the EPS of the operator 1 meets a requirement of MINT.

This is quite different from R17 MINT.

### Difference 1:

R17 only studies MINT supported between 5GSs, and does not involve an EPS. That is, an eNodeB of the EPS does not broadcast related information, and the terminal does not access an EPS of the forbidden PLMN. In addition, because an EPS is commercially available, the smaller the changes to the EPS, the better.

### Difference 2:

Initial registration is used in R17. If the terminal accesses the EPS by using a method of R17, the EPS needs to be enhanced with a new registration type and a new disaster random number, and the eNodeB of the EPS needs to broadcast corresponding information and the like, which causes a great change to the EPS.

Although the EPS of the PLMN 1 may be considered as a forbidden PLMN for the terminal, actually, both the EPS of the PLMN 1 and the 5GS of the PLMN 1 belong to a same operator. There is an N26 interface between the EPS and the 5GS, and an interoperation may be performed through the N26 interface to directly transfer the terminal from the 5GS to the EPS without requiring the terminal to re-register with the EPS.

Further, if a disaster occurs in a Network Functions (NF) performing an interoperation in the 5GS, even if the terminal needs to re-register with the EPS, a best solution should be that, based on an indication of the 5GS or a 5G radio access network (NG Radio Access Network, NG-RAN), the terminal is to register with the EPS without carrying a new registration type.

It should also be noted that the terminal is a terminal of the PLMN 1, and there is completely no security context between the terminal and the PLMN 2. In this case, on the one hand, the terminal cannot receive a message sent by the PLMN 2 because either the terminal cannot decrypt the message from the PLMN 2, or the entire message is directly discarded by the terminal. On the other hand, a message from the PLMN 1 is forwarded to the PLMN 2 by using the RAN, and the PLMN 2 cannot identify the message because an encryption manner of each PLMN is different.

The terminal and the network side cannot decrypt messages sent to each other. If plaintext is sent, the plaintext may be discarded by the other party because it is specified in a standard that after SMC, all NAS messages need to be integrity protect and encrypted.

It may be understood that, this embodiment of this application studies, when a CN disaster occurs in the OP1, how the terminal is transferred to the OP2 to use a disaster roaming service provided by the OP2.

The disaster roaming method provided in the embodiments of this application may be performed by a disaster roaming apparatus. In an embodiment of this application, that the disaster roaming apparatus performs the disaster roaming method is used as an example to describe the disaster roaming apparatus provided in the embodiments of this application.

FIG. 10 is a schematic diagram 1 of a structure of a disaster roaming apparatus according to an embodiment of this application. As shown in FIG. 10, the disaster roaming apparatus 1000 is applied to a terminal and includes:
an obtaining module 1001, configured to obtain first information, where the first information is information related to a disaster condition DC of a first network; and
a processing module 1002, configured to perform, based on the first information, a first operation responding to the DC of the first network.

According to the disaster roaming apparatus provided in this embodiment of this application, the obtaining module of the terminal can obtain the first information related to the DC of the first network, and then the processing module of the terminal performs, based on the first information, the first operation responding to the DC of the first network, to mitigate impact of a disaster, on the terminal, occurring on a network side, that is, in the first network.

In some embodiments, the first network may be a network with a DC, or the first network may be a network with a CN DC.

In some embodiments, the first information may include at least one of the following:
1. first indication information, used by the terminal to determine that the first network is incapable of serving the terminal;
2. second indication information, used by the terminal to determine to access a second network;
3. third indication information, used to request the terminal to perform network selection;
4. fourth indication information, used to request the terminal to deregister or detach from the first network;
5. fifth indication information, used by the terminal to determine to perform a handover process from the first network to the second network or an interoperation process between the first network and the second network; or
6. sixth indication information, used by the terminal to determine to enter an idle state.

In some embodiments, the second network may be a network offering a disaster roaming service.

In some embodiments, the first operation may include at least one of the following:
(1) releasing a communication resource between the terminal and the first network;
(2) releasing a communication resource between the terminal and a first communication device;
(3) establishing a communication resource related to the second network with the first communication device;
(4) deregistering or detaching from the first network;
(5) entering an idle state;
(6) performing network selection;
(7) performing an interoperation process from the first network to the second network; or
(8) sending a registration request message to the second network.

In some embodiments, in a case that the first operation includes entering an idle state, the terminal in the idle state may meet any of the following:
a. radio resource control RRC of the terminal is in a connected state, and connection management CM of the terminal is in an idle state; and
b. RRC of the terminal is in an idle state, and CM of the terminal is in an idle state.

In some embodiments, the registration request message includes at least one of the following:
1. a registration type, used to indicate that the terminal performs registration related to a disaster condition;
2. an identifier ID of the first network;
3. an ID of the terminal; or
4. seventh indication information, used to indicate that the first network is incapable of serving the terminal.

In some embodiments, an implementation of performing the interoperation process from the first network to the second network may include:
sending at least one of the following target information to the second network:
1. an ID of the first network;
2. an ID of the terminal; or
3. seventh indication information, used to indicate that the first network is incapable of serving the terminal.

In some embodiments, the disaster roaming apparatus 1000 further includes:
a third sending module, configured to send second information, where the second information is used to indicate that the terminal has a capability of supporting the second network.

In some embodiments, that the first network is incapable of serving the terminal may include:

A core network CN disaster occurs in the first network; or the first network is in the DC.

In some embodiments, in a case that a radio access technology RAT of the first network is the same as that of the second network, the first operation includes at least one of the following: releasing the communication resource between the terminal and the first network, releasing the communication resource between the terminal and the first communication device, establishing the communication resource related to the second network with the first communication device, deregistering or detaching from the first network, entering an idle state, performing network selection, or sending the registration request message to the second network; or
in a case that the RAT of the first network is different from that of the second network, the first operation includes at least one of the following: releasing the communication resource between the terminal and the first network, releasing the communication resource between the terminal and the first communication device, establishing the communication resource related to the second network with the first communication device, deregistering or detaching from the first network, entering an idle state, performing network selection, performing the interoperation process from the first network to the second network, or sending the registration request message to the second network.

In some embodiments, the first information may further include an ID of the second network.

In some embodiments, the terminal may not perform network selection.

In some embodiments, an implementation of obtaining the first information by the terminal may include: The terminal receives the first information from the first communication device.

In some embodiments, the first information is represented based on at least one of the following:
(1) a cause value; or
(2) a bit indication.

In some embodiments, the first information may be carried in at least one of the following:
a. an RRC reconfiguration message;
b. an RRC release message; or
c. a system broadcast message.

In some embodiments, the obtaining module 1001 is further configured to obtain eighth indication information, where the eighth indication information is used by the terminal to determine that the first network is capable of serving the terminal.

The processing module 1002 is further configured to perform, based on the eighth indication information, at least one of the following:
1. performing network selection; or
2. deregistering or detaching from the second network.

In some embodiments, the eighth indication information may be carried in at least one of the following:
(1) a deregistration request message or a detach request message;
(2) a UE configuration update command message;
(3) a registration reject message; or
(4) a downlink non-access stratum transport message.

In some embodiments, that the first network is capable of serving the terminal may include:

In a case that the CN disaster of the first network ends or the DC of the first network ends, the first network is capable of serving the terminal.

In some embodiments, the obtaining module 1001 is further configured to obtain ninth indication information, where the ninth indication information is used to request the terminal to re-register with the second network.

The third sending module is further configured to send the registration request message based on the ninth indication information.

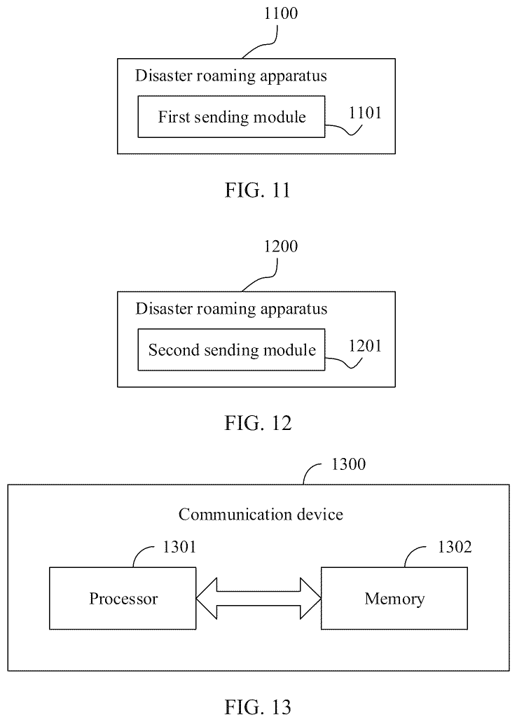

FIG. 11 is a schematic diagram 2 of a structure of a disaster roaming apparatus according to an embodiment of this application. As shown in FIG. 11, the disaster roaming apparatus 1100 is applied to a first communication device and includes:
a first sending module 1101, configured to send first information to a terminal, where the first information is information related to a disaster condition DC of a first network.

According to the disaster roaming apparatus provided in this embodiment of this application, the first sending module of the first communication device can send the first information related to the DC of the first network to the terminal, so that the terminal performs, based on the first information, the first operation responding to the DC of the first network, to mitigate impact of a disaster, on the terminal, occurring on a network side, that is, in the first network.

In some embodiments, the first network may be a network with a DC, or the first network may be a network with a CN DC.

In some embodiments, the first information may include at least one of the following:
1. first indication information, used by the terminal to determine that the first network is incapable of serving the terminal;
2. second indication information, used by the terminal to determine to access a second network;
3. third indication information, used to request the terminal to perform network selection;
4. fourth indication information, used to request the terminal to deregister or detach from the first network;
5. fifth indication information, used by the terminal to determine to perform a handover process from the first network to the second network or an interoperation process between the first network and the second network; or
6. sixth indication information, used by the terminal to determine to enter an idle state.

In some embodiments, the second network may be a network offering a disaster roaming service.

In some embodiments, that the first network is incapable of serving the terminal may include:

A core network CN disaster occurs in the first network; or the first network is in the DC.

In some embodiments, the first information may further include an ID of the second network.

In some embodiments, the first information is represented based on at least one of the following:
(1) a cause value; or
(2) a bit indication.

In some embodiments, the first information may be carried in at least one of the following:
a. an RRC reconfiguration message;
b. an RRC release message; or
c. a system broadcast message.

In some embodiments, the first sending module 1101 is further configured to send eighth indication information to a terminal, where the eighth indication information is used by the terminal to determine that a first network is capable of serving the terminal.

In some embodiments, the eighth indication information may be carried in at least one of the following:
(1) a deregistration request message or a detach request message;
(2) a UE configuration update command message;
(3) a registration reject message; or
(4) a downlink non-access stratum transport message.

In some embodiments, that the first network is capable of serving the terminal may include:

In a case that a core network CN disaster of the first network ends or the DC of the first network ends, the first network is capable of serving the terminal.

In some embodiments, the first sending module 1101 is further configured to send ninth indication information to the terminal, where the ninth indication information is used to request the terminal to re-register with the second network.

FIG. 12 is a schematic diagram 3 of a structure of a disaster roaming apparatus according to an embodiment of this application. As shown in FIG. 12, the disaster roaming apparatus 1200 is applied to a second network and includes:
a second sending module 1201, configured to send eighth indication information to a terminal, where the eighth indication information is used by the terminal to determine that a first network is capable of serving the terminal.

According to the disaster roaming apparatus provided in this embodiment of this application, in a case that the first network can serve the terminal, the second sending module of the second network can indicate, by using the eighth indication information, the terminal that the first network is capable of serving the terminal, so that the terminal can return to the first network, and the first network serves the terminal to end disaster roaming.

In some embodiments, the first network may be a network with a DC, or the first network may be a network with a CN DC.

In some embodiments, the second network may be a network offering a disaster roaming service.

In some embodiments, the eighth indication information may be carried in at least one of the following:
(1) a deregistration request message or a detach request message;
(2) a UE configuration update command message;
(3) a registration reject message; or
(4) a downlink non-access stratum transport message.

In some embodiments, that the first network is capable of serving the terminal may include:

In a case that a core network CN disaster of the first network ends or a disaster condition DC of the first network ends, the first network is capable of serving the terminal.

In some embodiments, the second sending module 1201 is further configured to send ninth indication information to the terminal, where the ninth indication information is used to request the terminal to re-register with the second network.

In some embodiments, the disaster roaming apparatus 1200 further includes:
a receiving module, configured to receive a registration request message sent by the terminal, where
the registration request message includes at least one of the following:
1. a registration type, used to indicate that the terminal performs registration related to a disaster condition;
2. an identifier ID of the first network;
3. an ID of the terminal; or
4. seventh indication information, used to indicate that the first network is incapable of serving the terminal.

In some embodiments, the receiving module is further configured to receive at least one of the following target information sent by the terminal: an ID of the first network; an ID of the terminal; and seventh indication information, used to indicate that the first network is incapable of serving the terminal.

The receiving module is further configured to perform an interoperation process of the terminal from the first network to the second network based on the target information.

The disaster roaming apparatus in this embodiment of this application may be an electronic device, for example, an electronic device with an operating system, or may be a component in the electronic device, for example, an integrated circuit or a chip. The electronic device may be a terminal, or may be another device other than the terminal. For example, the terminal may include but is not limited to the foregoing listed type of the terminal 11. The another device may be a server, a Network Attached Storage (NAS), or the like. This is not specifically limited in the embodiments of this application.

The disaster roaming apparatus provided in this embodiment of this application can implement the processes implemented in the method embodiments of FIG. 3 to FIG. 9, and achieve a same technical effect. To avoid repetition, details are not described herein again.

FIG. 13 is a schematic diagram of a structure of a communication device according to an embodiment of this application. As shown in FIG. 13, an embodiment of this application further provides a communication device 1300, including a processor 1301 and a memory 1302. The memory 1302 stores a program or instructions capable of running on the processor 1301. For example, when the communication device 1300 is a terminal, the program or the instructions are executed by the processor 1301 to implement the steps in the disaster roaming method embodiment on a terminal side, and a same technical effect can be achieved. When the communication device 1300 is a first communication device, the program or the instructions are executed by the processor 1301 to implement the steps in the disaster roaming method embodiment on a first communication device side, and a same technical effect can be achieved. When the communication device 1300 is a second network, the program or the instructions are executed by the processor 1301 to implement the steps in the disaster roaming method embodiment on a second network side, and a same technical effect can be achieved. To avoid repetition, details are not described herein again.

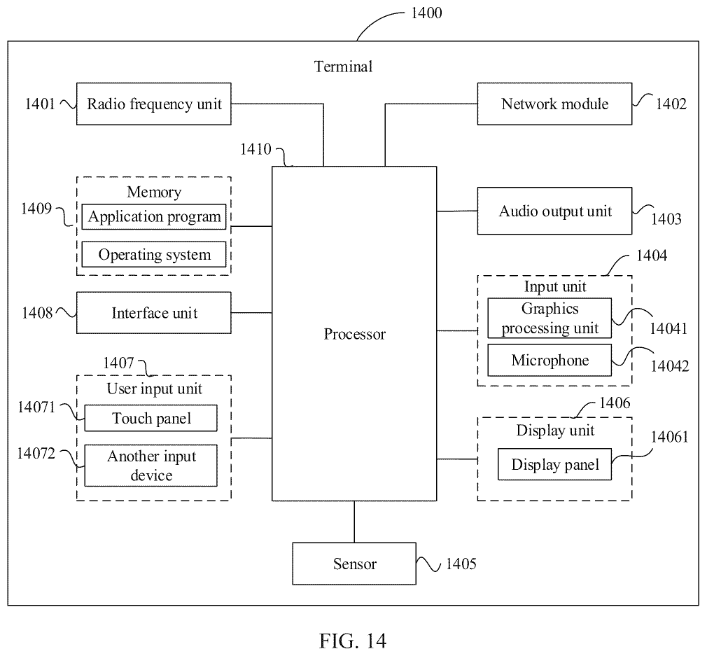

An embodiment of this application further provides a terminal, including a processor and a communication interface. The communication interface is configured to obtain first information, where the first information is information related to a disaster condition DC of a first network. The processor is configured to perform, based on the first information, a first operation responding to the DC of the first network. This terminal embodiment is corresponding to the foregoing terminal-side method embodiment. Each implementation process and each implementation of the foregoing method embodiment may be applicable to this terminal embodiment, and a same technical effect can be achieved. FIG. 14 is a schematic diagram of a hardware structure of a terminal according to an embodiment of this application.

The terminal 1400 includes but is not limited to at least a part of components of a radio frequency unit 1401, a network module 1402, an audio output unit 1403, an input unit 1404, a sensor 1405, a display unit 1406, a user input unit 1407, an interface unit 1408, a memory 1409, a processor 1410, and the like.

A person skilled in the art may understand that the terminal 1400 may further include a power supply (for example, a battery) that supplies power to each component.

The power supply may be logically connected to the processor 1410 by using a power supply management system, to implement functions such as charging management, discharging management, and power consumption management by using the power supply management system. A structure of the terminal shown in FIG. 14 does not constitute a limitation on the terminal. The terminal may include more or fewer components than those shown in the figure, or combine some components, or have different component arrangements. Details are not described herein.

It should be understood that in this embodiment of this application, the input unit 1404 may include a Graphics Processing Unit (GPU) 14041 and a microphone 14042. The graphics processing unit 14041 processes image data of a static picture or a video obtained by an image capture apparatus (for example, a camera) in a video capture mode or an image capture mode. The display unit 1406 may include a display panel 14061, and the display panel 14061 may be configured in a form of a liquid crystal display, an organic light-emitting diode, or the like. The user input unit 1407 includes at least one of a touch panel 14071 and another input device 14072. The touch panel 14071 is also referred to as a touchscreen. The touch panel 14071 may include two parts: a touch detection apparatus and a touch controller. The another input device 14072 may include but is not limited to a physical keyboard, a function key (for example, a volume control key or an on/off key), a trackball, a mouse, and a joystick. Details are not described herein.

In this embodiment of this application, after receiving downlink data from a network side device, the radio frequency unit 1401 may transmit the downlink data to the processor 1410 for processing. In addition, the radio frequency unit 1401 may send uplink data to the network side device. Usually, the radio frequency unit 1401 includes but is not limited to an antenna, an amplifier, a transceiver, a coupler, a low-noise amplifier, a duplexer, and the like.

The memory 1409 may be configured to store a software program or instructions and various types of data. The memory 1409 may mainly include a first storage area for storing a program or instructions and a second storage area for storing data. The first storage area may store an operating system, an application program or instructions required by at least one function (for example, a sound playback function or an image playback function), and the like. In addition, the memory 1409 may include a volatile memory or a non-volatile memory, or the memory 1409 may include both a volatile memory and a non-volatile memory. The non-volatile memory may be a Read-Only memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1409 in this embodiment of this application includes but is not limited to these memories and any other suitable type of memory.

The processor 1410 may include one or more processing units. In some embodiments, the processor 1410 integrates an application processor and a modem processor, where the application processor mainly processes operations related to an operating system, a user interface, an application program, and the like, and the modem processor mainly processes a wireless communication signal, such as a baseband processor. It may be understood that the modem processor may not be integrated into the processor 1410.

An embodiment of this application further provides a first communication device, including a processor and a communication interface. The communication interface is configured to send first information to a terminal, and the first information is information related to a disaster condition DC of a first network. The first communication device embodiment is corresponding to the first communication device method embodiment. Each implementation process and each implementation of the foregoing method embodiment may be applicable to the first communication device embodiment, and a same technical effect can be achieved.

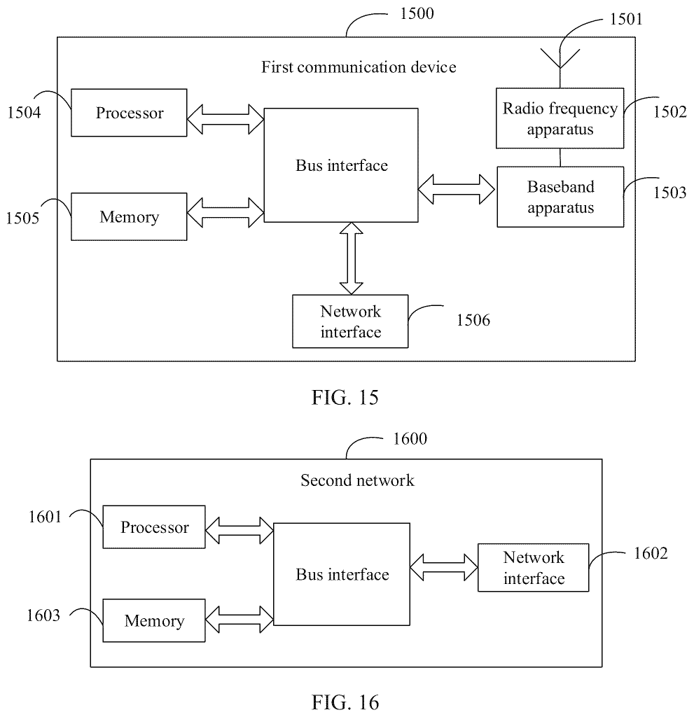

The embodiments of this application further provide a first communication device. FIG. 15 is a schematic diagram of a structure of a first communication device according to an embodiment of this application. As shown in FIG. 15, the first communication device 1500 includes an antenna 1501, a radio frequency apparatus 1502, a baseband apparatus 1503, a processor 1504, and a memory 1505. The antenna 1501 is connected to the radio frequency apparatus 1502. In an uplink direction, the radio frequency apparatus 1502 receives information by using the antenna 1501, and sends the received information to the baseband apparatus 1503 for processing. In a downlink direction, the baseband apparatus 1503 processes to-be-sent information, and sends processed information to the radio frequency apparatus 1502. After processing the received information, the radio frequency apparatus 1502 sends processed information by using the antenna 1501.

The method performed by the first communication device in the foregoing embodiment may be implemented in the baseband apparatus 1503, and the baseband apparatus 1503 includes a baseband processor.

For example, the baseband apparatus 1503 may include at least one baseband board. A plurality of chips are disposed on the baseband board. As shown in FIG. 15, one of the chips is, for example, the baseband processor, and is connected to the memory 1505 by using a bus interface, to invoke a program in the memory 1505 to perform an operation of a network device shown in the foregoing method embodiment.

The first communication device may further include a network interface 1506, and the interface is, for example, a common public radio interface (CPRI).

The first communication device 1500 in this embodiment of the present application further includes instructions or a program stored in the memory 1505 and capable of running on the processor 1504. The processor 1504 invokes the instructions or the program in the memory 1505 to perform the method performed by the modules shown in FIG. 6, and a same technical effect is achieved. To avoid repetition, details are not described herein again.

An embodiment of this application further provides a second network. FIG. 16 is a schematic diagram of a structure of a second network according to an embodiment of this application. As shown in FIG. 16, the second network 1600 includes a processor 1601, a network interface 1602, and a memory 1603. The network interface 1602 is, for example, a common public radio interface (CPRI).

The second network 1600 in this embodiment of the present application further includes instructions or a program stored in the memory 1603 and capable of running on the processor 1601. The processor 1601 invokes the instructions or the program in the memory 1603 to perform the method performed by the modules shown in FIG. 12, and a same technical effect is achieved. To avoid repetition, details are not described herein again.

An embodiment of this application further provides a readable storage medium. The readable storage medium stores a program or instructions. The program or the instructions are executed by a processor to implement the processes in the disaster roaming method embodiment, and a same technical effect can be achieved. To avoid repetition, details are not described herein again.

The processor is a processor in the terminal in the foregoing embodiments. The readable storage medium may be non-volatile, or may be non-transient. The readable storage medium may include a computer-readable storage medium such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the disaster roaming method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/a program product. The computer program/the program product is stored in a storage medium. The computer program/the program product is executed by at least one processor to implement the processes in the disaster roaming method embodiment, and a same technical effect can be achieved. To avoid repetition, details are not described herein again.

An embodiment of this application further provides a disaster roaming system, including a terminal, a first communication device, and a second network. The terminal may be configured to perform the steps of the disaster roaming method on the terminal side, the first communication device may be configured to perform the steps of the disaster roaming method on the first communication device side, and the second network may be configured to perform the steps of the disaster roaming method on the second network side.

It should be noted that, the terms “include”, “comprise”, or any other variation thereof in this specification are intended to cover a non-exclusive inclusion, so that a process, method, article, or apparatus that includes a list of elements includes the elements, and also includes other elements that are not expressly listed, or further includes elements inherent to such a process, method, article, or apparatus. Without more limitations, elements defined by the sentence “including one” does not exclude that there are still other same elements in the process, method, article, or apparatus that includes the elements. In addition, it should be noted that the scope of the method and apparatus in the implementations of this application is not limited to performing functions in a sequence shown or discussed, and may further include performing functions in a basically simultaneous manner or in a reverse sequence based on related functions. For example, the described method may be performed in an order different from the described order, and various steps may be added, omitted, or combined. In addition, features described with reference to some examples may be combined in other examples.

A person of ordinary skill in the art may be aware that the units and the algorithm steps in the examples described with reference to the embodiments disclosed in this specification can be implemented by using electronic hardware or a combination of computer software and electronic hardware. Whether these functions are performed in a hardware or software manner depends on particular applications and design constraints of the technical solutions. A person skilled in the art may use different methods to implement the described functions for each specific application, but it should not be considered that such an implementation goes beyond the scope of the present disclosure.

It may be clearly understood by a person skilled in the art that for convenience and brevity of description, for specific working processes of the described system, apparatus, and unit, refer to the corresponding processes in the foregoing method embodiments. Details are not described herein again.

In the embodiments provided in this application, it should be understood that the disclosed apparatus and method may be implemented in another manner. For example, the apparatus embodiment described above is merely an example. For example, the unit division is merely logical function division, and there may be another division manner in actual implementation. For example, a plurality of units or components may be combined or integrated into another system, or some features may be ignored or not performed. In addition, the displayed or discussed mutual couplings, direct couplings, or communication connections may be implemented by using some interfaces. The indirect couplings or communication connections between the apparatuses or units may be implemented in an electrical, mechanical, or another form.

The units described as separate parts may or may not be physically separate, and parts displayed as units may or may not be physical units, may be located at one position, or may be distributed on a plurality of network units. Some or all of the units may be selected based on actual requirements to achieve the objectives of the solutions of embodiments.

In addition, the functional units in the embodiments of the present disclosure may be integrated into one processing unit, or each of the units may exist alone physically, or two or more units may be integrated into one unit.

Based on the descriptions in the foregoing implementations, a person skilled in the art may clearly learn that the method in the foregoing embodiment may be implemented by software in addition to a necessary universal hardware platform or by hardware. In most circumstances, the former is a better implementation. Based on such an understanding, the technical solution of this application essentially, or a part contributing to a related art, may be embodied in a form of a computer software product. The computer software product is stored on a storage medium (for example, a ROM/RAM, a magnetic disk, or an optical disc), and includes several instructions to enable a terminal (which may be a mobile phone, a computer, a server, an air conditioner, a network device, or the like) to perform the method in the embodiments of this application.

It may be understood that these embodiments described in the embodiments of the present disclosure may be implemented by hardware, software, firmware, middleware, microcode, or a combination thereof. For the hardware implementation, modules, units, and subunits may be implemented in one or more Application Specific Integrated Circuits (ASIC), a Digital Signal Processor (DSP), a digital signal processing device (DSP Device, DSPD), a Programmable Logic Device (PLD), a Field-Programmable Gate Array (FPGA), a general-purpose processor, a controller, a microcontroller, a microprocessor, other electronic units configured to perform the functions described in the present disclosure, or a combination thereof.

For the software implementation, the techniques described in the embodiments of the present disclosure may be implemented by using modules (for example, processes and functions) that execute the functions described in the embodiments of the present disclosure. Software code may be stored in a memory and executed by a processor. The memory may be implemented in or outside the processor.

The embodiments of this application are described with reference to the accompanying drawings. However, this application is not limited to the foregoing specific implementations. The foregoing specific implementations are merely examples, rather than restrictive. Many forms made by a person of ordinary skill in the art under inspiration of this application and without departing from the objectives and the protection scope of the claims of this application shall fall within the protection scope of this application.

1. A disaster roaming method, comprising:
obtaining, by a terminal, first information, wherein the first information is information related to a disaster condition (DC) of a first network; and
performing, by the terminal based on the first information, a first operation responding to the DC of the first network.

2. The disaster roaming method according to claim 1, wherein the first information comprises at least one of the following:
first indication information, used by the terminal to determine that the first network is incapable of serving the terminal;
second indication information, used by the terminal to determine to access a second network;
third indication information, used to request the terminal to perform network selection;
fourth indication information, used to request the terminal to deregister or detach from the first network;
fifth indication information, used by the terminal to determine to perform a handover process from the first network to the second network or an interoperation process between the first network and the second network; or
sixth indication information, used by the terminal to determine to enter an idle state.

3. The disaster roaming method according to claim 2, wherein the first operation comprises at least one of the following:
releasing a communication resource between the terminal and the first network;
releasing a communication resource between the terminal and a first communication device;
establishing a communication resource related to the second network with the first communication device;
deregistering or detaching from the first network;
entering an idle state;
performing network selection;
performing an interoperation process from the first network to the second network; or
sending a registration request message to the second network.

4. The disaster roaming method according to claim 3, wherein when the first operation comprises entering an idle state, the terminal in the idle state meets any of the following:
radio resource control (RRC) of the terminal is in a connected state, and connection management (CM) of the terminal is in an idle state; or
RRC of the terminal is in an idle state, and CM of the terminal is in an idle state.

5. The disaster roaming method according to claim 3, wherein the registration request message comprises at least one of the following:
a registration type, used to indicate that the terminal performs registration related to a disaster condition;
an identifier (ID) of the first network;
an ID of the terminal; or
seventh indication information, used to indicate that the first network is incapable of serving the terminal.

6. The disaster roaming method according to claim 3, wherein the performing an interoperation process from the first network to the second network comprises:
sending at least one of the following target information to the second network:
an ID of the first network;
an ID of the terminal; or
seventh indication information, used to indicate that the first network is incapable of serving the terminal.

7. The disaster roaming method according to claim 6, further comprising:
sending, by the terminal, second information, wherein the second information is used to indicate that the terminal has a capability of supporting the second network.

8. The disaster roaming method according to claim 2, wherein that the first network is incapable of serving the terminal comprises:
a core network (CN) disaster occurs in the first network; or the first network is in the DC.

9. The disaster roaming method according to claim 3, wherein:
when a radio access technology (RAT) of the first network is the same as that of the second network, the first operation comprises at least one of the following: releasing the communication resource between the terminal and the first network, releasing the communication resource between the terminal and the first communication device, establishing the communication resource related to the second network with the first communication device, deregistering or detaching from the first network, entering an idle state, performing network selection, or sending the registration request message to the second network; or
when the RAT of the first network is different from that of the second network, the first operation comprises at least one of the following: releasing the communication resource between the terminal and the first network, releasing the communication resource between the terminal and the first communication device, establishing the communication resource related to the second network with the first communication device, deregistering or detaching from the first network, entering an idle state, performing network selection, performing the interoperation process from the first network to the second network, or sending the registration request message to the second network.

10. The disaster roaming method according to claim 2, wherein the first information further comprises an ID of the second network.

11. The disaster roaming method according to claim 10, wherein the terminal does not perform network selection.

12. The disaster roaming method according to claim 3, wherein the obtaining, by a terminal, first information comprises:
receiving, by the terminal, the first information from the first communication device.

13. The disaster roaming method according to claim 12, wherein the first information is represented by at least one of the following:
a cause value; or
a bit indication.

14. The disaster roaming method according to claim 12, wherein the first information is carried in at least one of the following:
an RRC reconfiguration message;
an RRC release message; or
a system broadcast message.

15. The disaster roaming method according to claim 8, further comprising:
obtaining, by the terminal, eighth indication information, wherein the eighth indication information is used by the terminal to determine that the first network is capable of serving the terminal; and
performing, by the terminal based on the eighth indication information, at least one of the following:
performing network selection; or
deregistering or detaching from the second network.

16. The disaster roaming method according to claim 15, wherein the eighth indication information is carried in at least one of the following:
a deregistration request message or a detach request message;
a UE configuration update command message;
a registration reject message; or
a downlink non-access stratum transport message.

17. The disaster roaming method according to claim 15, wherein that the first network is capable of serving the terminal comprises:
when the CN disaster of the first network ends or the DC of the first network ends, the first network is capable of serving the terminal.

18. The disaster roaming method according to claim 14, wherein before the obtaining, by the terminal, eighth indication information, the method further comprises:
obtaining, by the terminal, ninth indication information, wherein the ninth indication information is used to request the terminal to re-register with the second network; and
sending, by the terminal, the registration request message based on the ninth indication information.

19. A terminal, comprising: a memory storing a computer program; and a processor coupled to the memory and configured to execute the computer program to perform operations comprising:
obtaining first information, wherein the first information is information related to a disaster condition (DC) of a first network; and
performing, based on the first information, a first operation responding to the DC of the first network.

20. A non-transitory computer-readable storage medium, storing a computer program, wherein the computer program, when executed by a processor, causes the processor to perform operations comprising:
obtaining, by a terminal, first information, wherein the first information is information related to a disaster condition (DC) of a first network; and
performing, by the terminal based on the first information, a first operation responding to the DC of the first network.
